(19) United States
(12) Patent Application Publication
(10) Pub. No.: US 2012/0005450 A1
(43) Pub. Date: Jan. 5, 2012

(54) USER CONTROL OF FILE DATA AND METADATA BLOCKS

(75) Inventors: Shashidhar Bomma, Cotton Wood Heights, UT (US); Robert Wright Thompson, Austin, TX (US)

(73) Assignee: International Business Machines Corporation, Armonk, NY (US)

(21) Appl. No.: 12/829,419

(22) Filed: Jul. 2, 2010

(51) Int. Cl. G06F 12/00

(52) U.S. Cl. 711/171; 711/E12.001

(57) ABSTRACT

A method enables a user to control the allocation in a file system of file data and metadata blocks by determining ranges of unallocated contiguous blocks in the file system. The method allocates to the user a metadata storage range of contiguous blocks within one of ranges of unallocated contiguous blocks. The method further allocates to the user a data storage range of contiguous blocks within the range of unallocated contiguous blocks. The method may then allocate to the user ranges of contiguous blocks within the allocated data storage range for storage of respective files.

### BACKGROUND OF THE INVENTION

1. Technical Field

The present invention relates generally to the field of data storage, and more particularly to a method of and system for allocating to a user contiguous blocks in a file system for storage of data and metadata.

2. Description of the Related Art

Computer storage systems store the actual file data and metadata on physical disk drives or disk arrays. A disk drive comprises a stack of disks mounted to rotate together about a spindle. Each disk is coated with magnetic material. Read and write heads are movably mounted with respect to the disks. The disks are spun at high speed and the read and write heads are moved in and out to read data from or write data to the spinning disks. A disk controller controls the movement of the heads, thereby controlling where the data is written to or read from.

The actual storage of files on physical media is very complex. This complexity is hidden from the user or the application by the computer operating system, which uses various levels of abstraction. The user or application sees files stored in a relatively simple file system. The user creates a file and the operating system handles how and where the data of the file is actually stored.

When the user creates a file, the operating system allocates a certain amount of space in the file system for the file and in turn allocates a certain amount of space on the physical disk for storage of the file. Over time, as the user works with the file the file may grow larger than the space originally allocated for storage of the file. The operating system simply stores part of the file in the originally allocated space and rest of the file in non-contiguous newly allocated space, thereby fragmenting the file.

As the user works with multiple files, all of the files may become fragmented. Fragmentation adds to the complexity of file storage. This complexity is hidden from the user, but the complexity of fragmentation degrades the performance of the system as the storage system has to assemble the file from multiple locations.

### SUMMARY OF THE INVENTION

Embodiments of the present invention provide methods, systems, and computer program products that enable a user to control the allocation in a file system of file data and metadata blocks. An embodiment of a method according to the present invention determines ranges of unallocated contiguous blocks in the file system. The method allocates to the user a metadata storage range of contiguous blocks within one of ranges of unallocated contiguous blocks. The method further allocates to the user a data storage range of contiguous blocks within the range of unallocated contiguous blocks. The method may then allocate to the user ranges of contiguous blocks within the allocated data storage range for storage of respective files.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 is a block diagram of an embodiment of a system according to the present invention;

FIG. 2 is a block diagram of an alternative embodiment of a system according to the present invention;

FIG. 3 is a block diagram of a storage system;

FIG. 4A-FIG. 4D comprise pictorial views of logical volume block allocation according to the present invention;

FIG. 5 is a high-level flowchart of an embodiment of logical volume block allocation according to the present invention;

FIG. 6 is a flowchart of an embodiment of data storage block allocation of FIG. 5;

FIG. 7 is a flowchart of an embodiment of metadata storage block allocation of FIG. 5;

FIG. 8 is a flowchart of an embodiment file data and metadata block allocation according to the present invention; and,

FIG. 9 is a block diagram of a computing device in which features of the present invention may be implemented.

### DETAILED DESCRIPTION OF THE PREFERRED EMBODIMENT

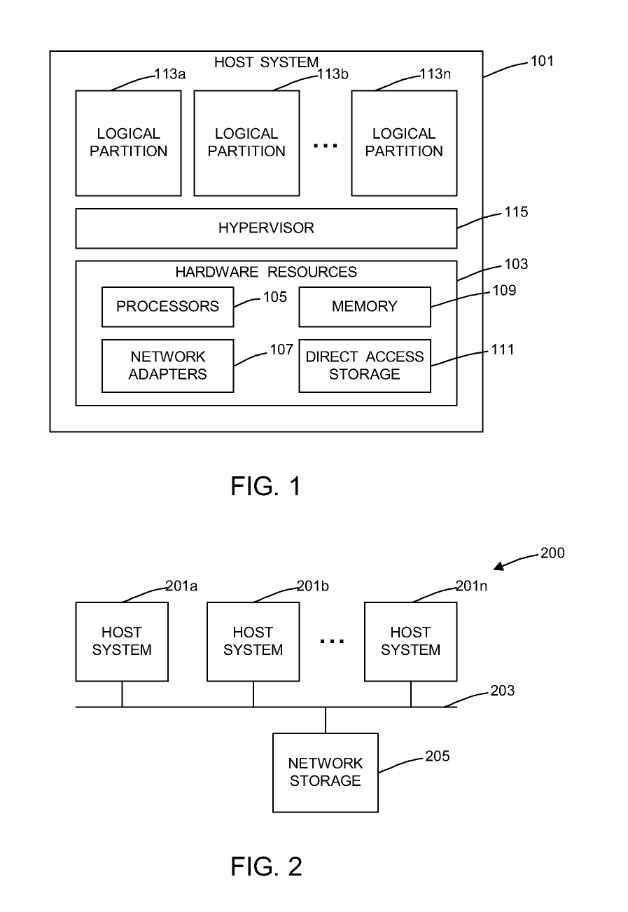

Referring now to the drawings, and first to FIG. 1, a host system is 101 includes hardware resources 103. Hardware resources 103 include, among other things, a processor or processors 105, network adapters 107, memory 109, and direct access storage 111. Direct access storage 111 preferably includes one or more disc drives (not shown in FIG. 1).

Host system 101 is virtualized system in that it hosts logical partitions 113. As is known to those skilled in the art, a logical partition is a division of the resources 103 of host system 101 into sets of resources so that each set of resources can be operated independently with its own operating system instance and application or applications. Each logical partition 113, and the application or applications running therein, may be used by one or more users.

Host system 101 includes a hypervisor 115. Hypervisor 115 is a software layer that provides the foundation for virtualization of host system 101. Hypervisor 115 enables the hardware resources 103 of host system 101 to be divided among logical partitions 113, and it ensures strong isolation between them. Hypervisor 115 is responsible for dispatching the respective workloads of logical partitions 113 across hardware resources 106. Hypervisor 115 also enforces partition security and it can provide inter-partition communication.

Referring to FIG. 2, an alternative system according to the present invention is designated generally by the numeral 200. System 200 includes a plurality of host systems 201. Each host system 201 may be virtualized system, such as host system 101 of FIG. 1, or a standalone, single user, computer. Each host system 201 includes hardware resources of the type described with reference to FIG. 1, as well as operating system and application instances.

Each host system 201 is coupled through a network 203 to a network storage system 205. Network 203 may be of any of any suitable configuration and may comprise a storage area network. Network storage 205 provides storage to host systems 201.

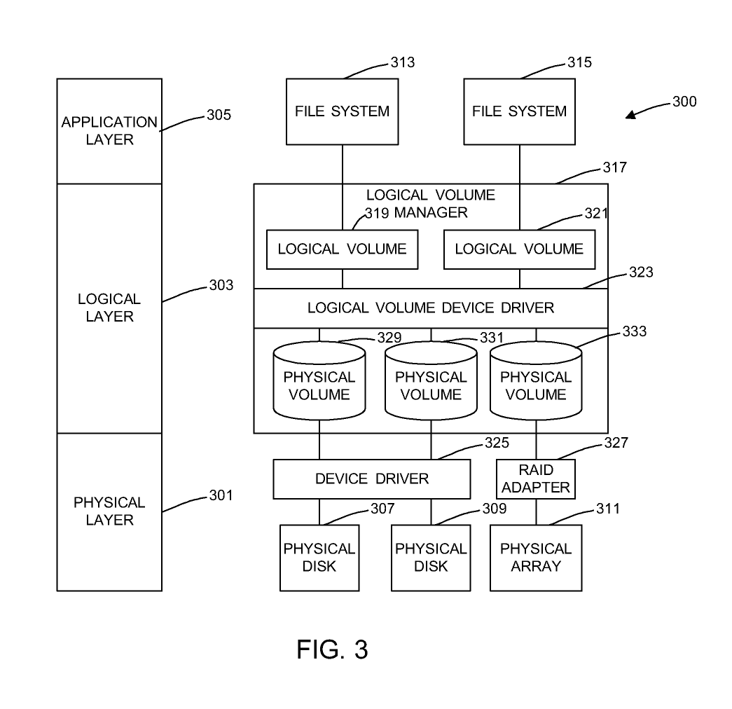

FIG. 3 is a block diagram of an example of a storage system 300. Storage system 300 comprises layers of abstraction including a physical layer 301, a logical layer 303, and an application layer 305. Physical layer 301 includes actual storage media such as physical disks 307-309 and a physical array 311. Application layer 305 includes one or more file systems 313-315 that provide the user's or application's view of storage system 300.

Logical layer 303 comprises a logical volume manager 317. Logical volume manager 317 provides a set of operating system commands, library subroutines and other tools that allow the user to establish and control logical volume storage. Logical volume manager 317 controls the resources of physical layer 301 by mapping data between the user's view of the storage space provided by file systems 313-315 and logical volumes 319 and 321 and the actual physical disks 307-311. Logical volume manager 317 does this by using a layer of logical volume device driver code 323 that runs above the traditional physical device drivers, such as device driver 325 and RAID adapter 327. Logical volume device driver 323 maps logical volumes 319-321 onto physical volumes 329-333. Device driver 325 maps physical volumes 329 and 331 onto physical disks 307 and 309, respectively. RAID adapter 327 maps physical volume 333 onto physical array 311. This logical view of the disk storage is provided to applications and is independent of the underlying physical disk structure.

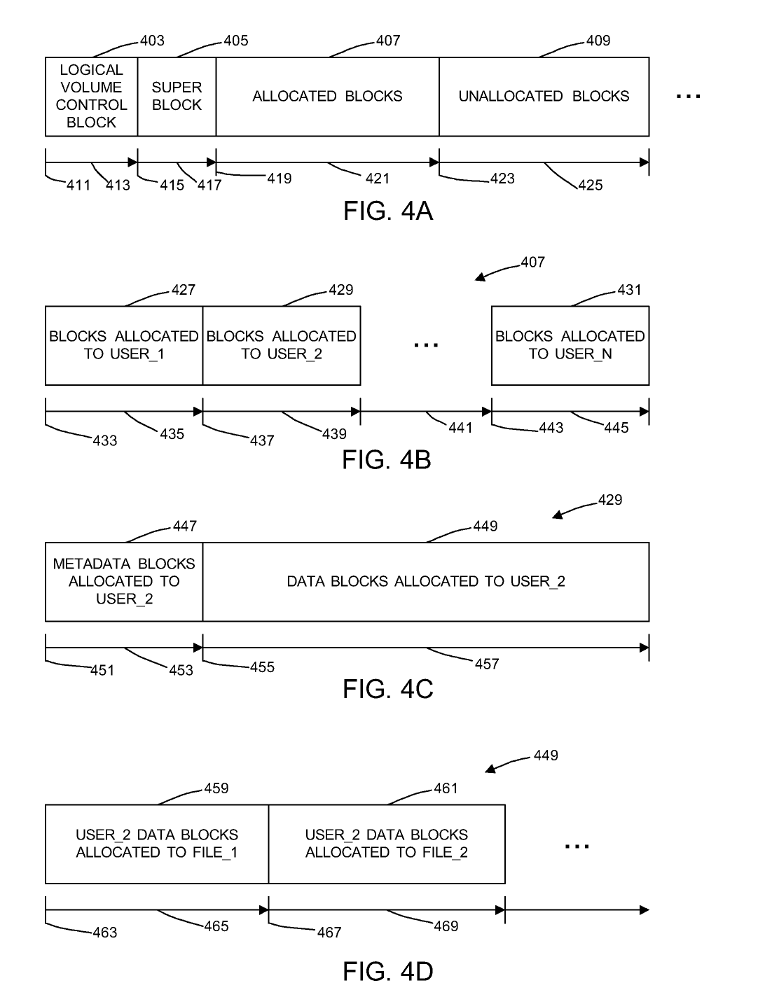

FIG. 4A is a pictorial representation of logical volume 401 according to an embodiment of the present invention. Logical volume 401 may be viewed as a linear array of blocks. In one embodiment of the present invention each block is four kilobytes (4K or 4096 bytes) in length. The first block of logical volume 401 is a logical volume control block 403. Logical volume control block 403 contains information about logical volume 401 such the date logical volume 401 was created, information about mirrored copies, etc. The second block of logical volume 401 is a super block 405. Super block 405 contains information about the file system, such as the file system size and index information about the blocks in the system. Following super block 405 logical volume 401 includes a plurality of sets of allocated blocks 407 and unallocated blocks 409. It should be recognized that FIG. 4A is not to scale and that sets of allocated blocks 407 and unallocated blocks 409 may be of any length.

The blocks and sets of blocks in logical volume 401 are identified by an offset and a range into logical volume 401. For example, the offset 411 of logical volume control block 403 is zero and its range 413 is one block. Similarly, the offset 415 of super block 405 is one and its range 417 is also one block. Then, the offset 419 of set of allocated blocks 407 is two and its range 421 is N blocks. The offset 423 of set of unallocated blocks 409 is two plus N and its range 425 is M blocks.

FIG. 4B is a pictorial view of the set of blocks 407 allocated to users according to the present invention. A first range of contiguous blocks 427 is allocated to a USER_1. A second range of contiguous blocks 429 is allocated to a USER_2. An nth range of contiguous blocks 431 is allocated to a USER_N. The manner in which the contiguous ranges of blocks are allocated will be described in detail hereinafter. Range 427 is identified by an offset 433, which in the illustrated example is two. The length 435 of range 427 is W blocks. Thus, the offset 437 of range 429 is two plus W and its length 439 is X blocks. Range 431 is separated from range 429 by Y blocks 441. Thus, the offset 443 of range 431 is two plus W plus X plus Y blocks and its length 445 is Z blocks.

FIG. 4C is a pictorial view of the range of contiguous blocks 429 allocated according to the present invention to USER_2. As will be explained in detail hereinafter, the system allocates to USER_2 a set of contiguous blocks 447 for storage of file metadata, which is sometimes referred to as inode data. The system also allocates to USER_2 a set of contiguous blocks 449 for storage of file data. Metadata blocks 447 are identified by an offset 451, which, referring to FIG. 4B, is two plus W. The range 453 of Metadata blocks 447 is P. Data blocks 449 are identified by an offset 455, which is two plus W plus P. The range of data blocks 449 is Q.

FIG. 4D is a pictorial view of contiguous data blocks 449 allocated according to the present invention to USER_2 for file storage. The system allocates to USER_2 a set of contiguous blocks 459 for storage of a FILE_1. According to the present invention, FILE_1 will always be stored in set of contiguous blocks 459, thereby avoiding fragmentation of FILE_1. Similarly, the system allocates to USER_2 a set of contiguous blocks 461 for storage of a FILE_2. The system may allocate to USER_2 all of the blocks of data blocks 449 for file data storage. Blocks 459 are identified by an offset 463 into the data blocks 449 allocated to USER_2. Thus, offset 463 is zero. According to the present invention the length 465 of blocks 459 is selected by USER_2 to be sufficient to store FILE_1, based on the user's estimate of the ultimate size of FILE_1. In the illustrated example the length 465 is Q blocks. Similarly, set of blocks 461 is identified by an offset 467, which is equal to Q. The length 467 is selected to be long enough to store FILE_2.

Occasionally, a user may underestimate the space required to store a particular file. As will be explained in detail hereinafter, in such cases the system puts the excess part of the file into normal file system storage. The user may then move the overflow part of the file into a portion of the user's allocation. The file would be fragmented, but in only one place. Alternatively, the user could obtain a new, larger, allocation for the file and consolidate the original part of the file and the overflow part into the new allocation, thereby avoiding fragmentation of the file.

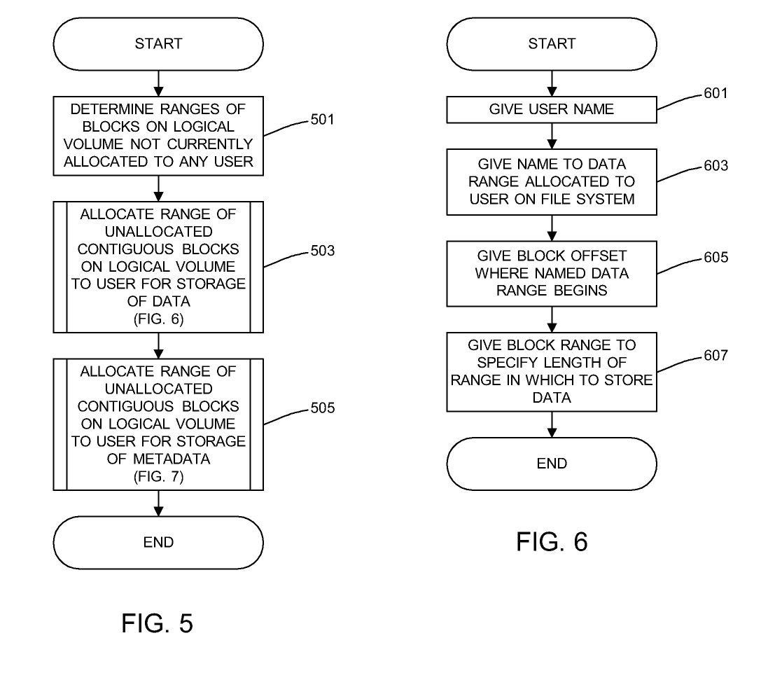

FIG. 5 is a high-level flowchart of an embodiment of block allocation according to the present invention. A user determines the ranges of blocks on the logical volume that are not currently allocated to any user, at processing block 501. In a command line environment, the user may invoke the system to output the ranges of unallocated blocks with a new function “fsmap <filesystem_name>” where filesystem_name is the name of the file system. After the user has determined the ranges of unallocated blocks, the user invokes the system to allocate to the user a range of unallocated contiguous blocks on the logical volume for storage of data, as indicated generally at processing block 503 and as illustrated in detail in FIG. 6. Referring to FIG. 6, the user provides to the system a user name, at block 601. The user provides to the system a name for the data range to be allocated, at block 603. The user provides to the system the offset into the logical volume for the named data range, at block 605. Finally, the user provides to the system the range of blocks to be allocated in which to store data, at processing block 607. In a command line environment, the user may perform the steps of FIG. 6 by entering a new command such as:

fs_data_alloc-b<data_range_name>-u<user>-<rblk_offset>:<blk_range>
<filesystem_name>
where:
<data_range_name> is the name of the range of contiguous blocks to be referred to in other commands;
<user> is the user to which the named data range is allocated;
<blk_offset> is the block offset where the named data range begins;
<blk_range> is the block length of the named data range; and,
<filesystem_name> is the name of the file system.

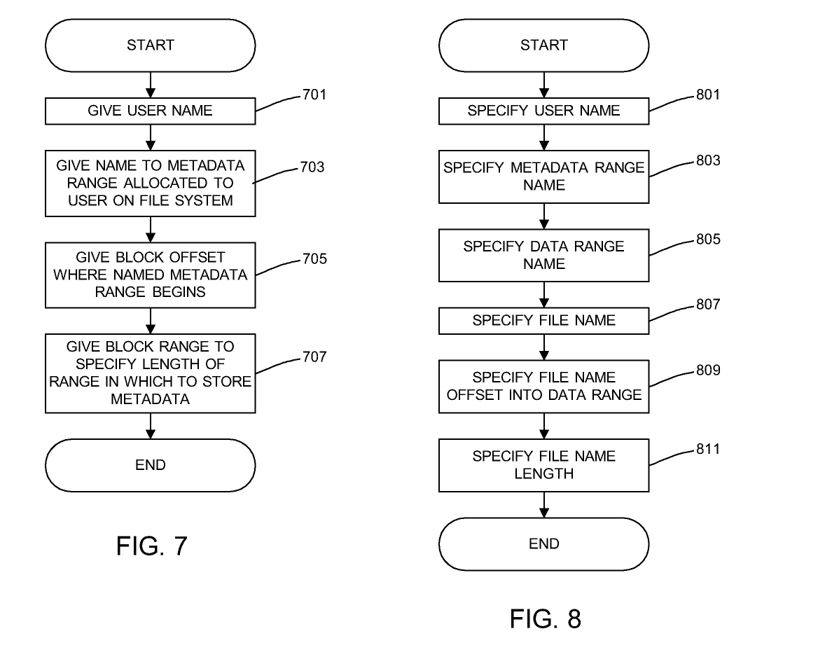

Referring again to FIG. 5, the user invokes the system to allocate to the user a range of unallocated contiguous blocks on the logical volume for storage of metadata or inode data, as indicated generally at processing block 505 and as illustrated in detail in FIG. 7. Referring to FIG. 7, the user gives the system a user name, at block 701. The user gives the system a name for the metadata range to be allocated, at block 703. The user gives the system the offset into the logical volume for the named metadata range, at block 705. Finally, the user gives the system the range of blocks to be allocated in which to store metadata, at processing block 707. In a command line environment, the user may perform the steps of FIG. 7 by entering a new command such as:

fs_file_alloc-b<inode_range_name>-u<user>-r<blk_offset>:<blk_range>
<filesystem_name>
where:
<inode_range_name> is the name of the range of contiguous blocks to be referred to in other commands;
<user> is the user to which the named metadata range is allocated;
<blk_offset> is the block offset where the named metadata range begins;
<blk_range> is the block length of the named metadata range; and,
<filesystem_name> is the name of the file system.

FIG. 8 is a flowchart illustrating an embodiment of allocation, in the ranges of contiguous blocks allocated to the user, ranges of blocks for storage of a particular file. The user specifies the name of the file, at block 801. The user specifies the metadata or inode range name, at block 803. The user specifies the data range name, at block 805. The metadata and data range names identify the ranges allocated according to FIGS. 5-7. The user then provides to the system a name for the file, at processing block 807. Then, the user gives the system an offset into the named data range for the named file, at processing block 809. Finally, the user gives the system a length in blocks to be allocated for storage of data for the named file. The user selects a length such that the entire named file may be stored in the space allocated. Generally, a user may use the “touch” command when creating a file and designating where the file's inode or metadata and the file's data blocks may be obtained, as follows:

# touch-i<inode_range_name>-d<data_range_name>:<off>;<len><filename>
where:
-i and -d show where the inode and file data reside for the named file; and,
<off>;<len> give the location of the file data relative to the named data range.

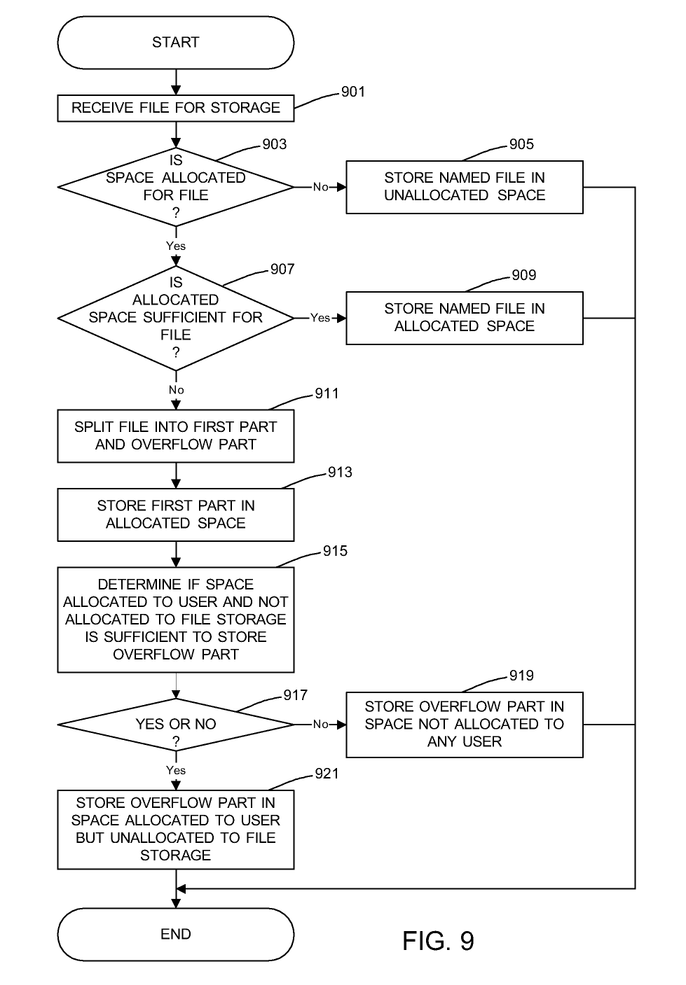

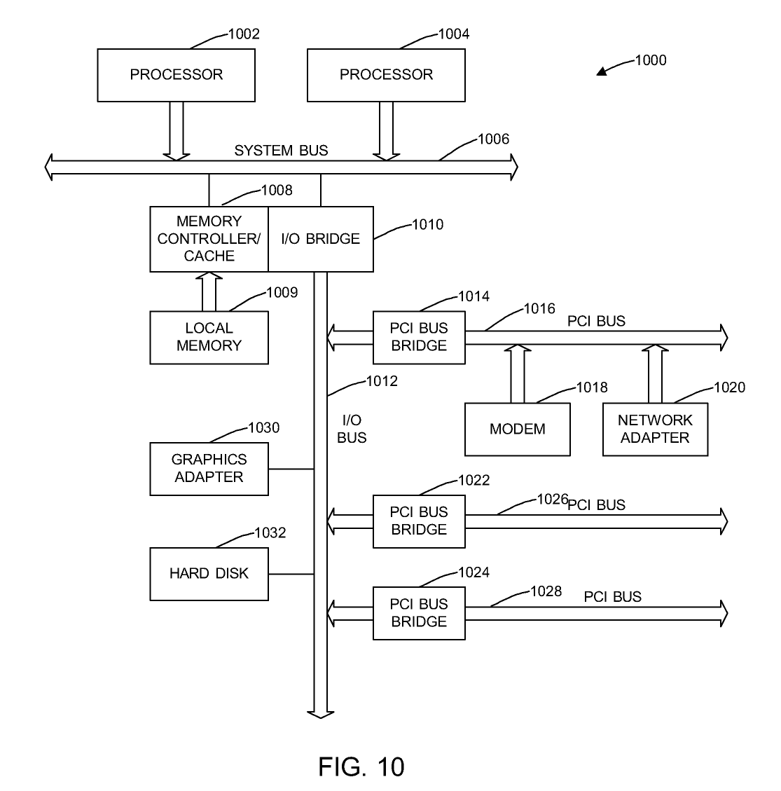

FIG. 9 is a flowchart of an embodiment of file storage according to the present invention. The file system receives from a user a file for storage, at block 901. The system determines, at decision block 903, if space has been allocated to the user for storage of the file. If not, the system stores the file space not allocated to any user, at block 905. If, as determined at decision block 903, space has been allocated to the user for storage of the file, the system determines, at decision block 907, if sufficient space has been allocated to the user for storage of the file. If so, the system stores the file in the space allocated to the user for storage of the file, at block 909. If, as determined at decision block 907, sufficient space has not been allocated to the user of the file, the system splits the file into a first part and an overflow part, at block 911, and stores the first part in the space allocated to user for storage of the file, at block 913. The system then determines if there is space allocated to the user but not allocated to storage of any particular file is sufficient to store the overflow part, at block 915. If not, as determined at decision block 917, the system stores the overflow part in space not allocated to any user, at block 919. If, as determined at decision block 917, there is sufficient space to store the overflow part in space allocated to the user but not allocated to storage of any particular file, the system stores the overflow part in such space, as indicated at block 921.

Embodiments of the present invention allow the user to determine where a particular file is stored on the logical volume using a “fileplace <filename>” command. In response to the fileplace command, the system outputs the size of the file and the logical extents of where the file is stored. For example, the user wants to determine where a file named 49288.004.errpt.out is stored. In response to a fileplace <49288.004.errpt.out> query, the system outputs:

# fileplace 49288.004.errpt.out
File: 49288.004.errpt.out Size: 291905 bytes Vol: /dev/hd3
Blk Size: 4096 Frag Size: 4096 Nfrags: 72
Logical Extent
--------------
00030528-00030591 64 frags 262144 Bytes, 88.9% user1_data_range
00034144-00034151 8 frags 32768 Bytes, 11.1%
default_filesystem_data_range

Thus, the user determines that file 49288.004.errpt.out, which has a size of 291905 bytes and requires seventy-two 4096-byte blocks for storage, is fragmented with a first part comprising 262144 bytes being stored space allocated to the user and an overflow part comprising 32768 bytes being stored in a default file system data range, not allocated to any user.

According to the present invention, the user may consolidate the file by allocating a new data range to the file and moving the file into the new data range. The user may allocate a new data range using the fs_data_alloc command discussed above. Embodiments of the present invention introduce a new blkmv command by which a user may move data from one data range to another. The blkmv command is illustrated as follows:
blkmv-d<data_range_name>:<off>:<len>-t<data_range_name>:<off>
where:
-d<data_range_name>:<off>:<len> is the source data range name, offset, and length; and,
-t<data_range_name>:<off> is the target data range name and offset.
   The blkmv command may also have an -f option that allows a named file to be relocated as follows:
blkmv-f<filename>:<off>:<len>-t<data_range_name>:<off>
where:
-f<filename>:<off>:<len> is the file to be moved, offset within file, and length of file to be moved; and,
-t<data_range_name>:<off> is the target data range name and offset.

Thus, the user may allocate the new data range using the fs_data_alloc command, as follows:
fs_data_alloc-b user1_data_range2-u user1-r 40000:10000/databasefs
   The user may then use the new blkmv-f option command, as follows:
blkmv-f 49288.004.errpt.out:0:72-t user1_data_range2:0
Where first 0 is file offset of 0
where 72 is length of file (64+8)
where second 0 is offset 0 of new user1_data_range2.
   After allocating the new data range and moving the file, the result of the fileplace command would be as follows:

# fileplace 49288.004.errpt.out
File: 429288.004.errpt.out Size: 291905 bytes Vol: /dev/hd3
Blk Size: 4096 Frag Size: 4096 Nfrags: 72
Logical Extent
-------------
00040000-00040071 72 frags 294912 Bytes, 100% user1_data_range2

Referring to FIG. 10, a block diagram of a data processing system that may be implemented as a server, such as server a 101 in FIG. 1, is depicted in accordance with a preferred embodiment of the present invention. Data processing system 1000 may be a symmetric multiprocessor (SMP) system including a plurality of processors 1002 and 1004 connected to system bus 1006. Alternatively, a single processor system may be employed. Also connected to system bus 1006 is memory controller/cache 1008, which provides an interface to local memory 1009. I/O bus bridge 1010 is connected to system bus 1006 and provides an interface to I/O bus 1012. Memory controller/cache 1008 and I/O bus bridge 1010 may be integrated as depicted.

Peripheral component interconnect (PCI) bus bridge 1014 connected to I/O bus 1012 provides an interface to PCI local bus 1016. A number of modems may be connected to PCI local bus 1016. Typical PCI bus implementations will support four PCI expansion slots or add-in connectors. Communications links to network 109 in FIG. 1 may be provided through modem 1018 and network adapter 1020 connected to PCI local bus 1016 through add-in boards. Additional PCI bus bridges 1022 and 1024 provide interfaces for additional PCI local buses 1026 and 1028, respectively, from which additional modems or network adapters may be supported. In this manner, data processing system 1000 allows connections to multiple network computers. A memory-mapped graphics adapter 1030 and hard disk 1032 may also be connected to I/O bus 1012 as depicted, either directly or indirectly.

Those of ordinary skill in the art will appreciate that the hardware depicted in FIG. 10 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 10 may be, for example, an IBM eServer pSeries system, a product of International Business Machines Corporation in Armonk, N.Y., running the Advanced Interactive Executive (AIX) operating system or LINUX operating system.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium or media having computer readable program code embodied thereon.

Any combination of one or more computer readable medium or media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program instructions comprising the program code for carrying out aspects of the present invention may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the foregoing flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the foregoing flowchart and/or block diagram block or blocks.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

From the foregoing, it will be apparent to those skilled in the art that systems and methods according to the present invention are well adapted to overcome the shortcomings of the prior art. While the present invention has been described with reference to presently preferred embodiments, those skilled in the art, given the benefit of the foregoing description, will recognize alternative embodiments. Accordingly, the foregoing description is intended for purposes of illustration and not of limitation.

What is claimed is:

1. A method, which comprises:
determining a range of unallocated contiguous blocks in a file system;
allocating to a user a metadata storage range of contiguous blocks within said range of unallocated contiguous blocks; and,
allocating to said user a data storage range of contiguous blocks within said range of unallocated contiguous blocks.

2. The method as claimed in claim 1, further comprising:
allocating to said user a range of contiguous blocks within said data storage range for storage of a first file.

3. The method as claimed in claim 2, further comprising:
receiving a request to save said first file;
saving metadata associated with said first file in said metadata storage range allocated to said user; and,
saving said first file in said range of contiguous blocks allocated for storage of said first file.

4. The method as claimed in claim 2, further comprising:
receiving a request to save said first file;
saving metadata associated with said first file in said metadata storage range allocated to said user;
determining if said range of contiguous blocks allocated for storage of said first file is large enough to store said first file;
if said range of contiguous blocks allocated for storage of said first file is determined to be not large enough to store said first file, splitting said first file into a first part and an overflow part;
saving said first part of said first file in said range of contiguous blocks allocated for storage of said first file; and,
saving said overflow part in a second range blocks.

5. The method as claimed in claim 1, wherein said allocating to said user said metadata storage range comprises:
identifying said user with a user name;
identifying said metadata storage range with a metadata storage range name;
specifying a block offset into said logical volume where said metadata storage range begins; and,
specifying a block range length of said metadata storage range.

6. The method as claimed in claim 1, wherein said allocating to said user said data storage range comprises:
identifying said user with a user name;
identifying said data storage range with a data storage range name;
specifying a block offset into said logical volume where said data storage range begins; and,
specifying a block range length of said data storage range.

7. The method as claimed in claim 1, wherein:
said allocating to said user said metadata storage range comprises:
identifying said user with a user name;
identifying said metadata storage range with a metadata storage range name;
specifying a block offset into said logical volume where said metadata storage range begins; and,
specifying a block range length of said metadata storage range; and,
said allocating to said user said data storage range comprises:
identifying said data storage range with a data storage range name;
specifying a block offset into said logical volume where said data storage range begins; and,
specifying a block range length of said data storage range.

8. The method as claimed in claim 7, further comprising:
allocating to said user a range of contiguous blocks within said data storage range for storage of a first file.

9. The method as claimed in claim 8, wherein allocating to said user a range of contiguous blocks within said data storage range for storage of said first file comprises:
specifying a name for said first file;
specifying said metadata storage name range for said first file;
specifying said data storage range name for said first file;
specifying an offset into said data storage range for said first file; and,
specifying a length for said first file.

10. A system, which comprises:
a file system;
means for determining a range of unallocated contiguous blocks in said file system;
means for allocating to a user a metadata storage range of contiguous blocks within said range of unallocated contiguous blocks; and,
means for allocating to said user a data storage range of contiguous blocks within said range of unallocated contiguous blocks.

11. The system as claimed in claim 10, further comprising:
means for allocating to said user a range of contiguous blocks within said data storage range for storage of a first file.

12. The system as claimed in claim 11, further comprising:
means for receiving a request to save said first file;
means for saving metadata associated with said first file in said metadata storage range allocated to said user; and,
means for saving said first file in said range of contiguous blocks allocated for storage of said first file.

13. The system as claimed in claim 11, further comprising:
means for receiving a request to save said first file;
means for saving metadata associated with said first file in said metadata storage range allocated to said user;
means for determining if said range of contiguous blocks allocated for storage of said first file is large enough to store said first file;
means for splitting said first file into a first part and an overflow part if said range of contiguous blocks allocated for storage of said first file is determined to be not large enough to store said first file;
means for saving said first part of said first file in said range of contiguous blocks allocated for storage of said first file; and,
means for saving said overflow part in a second range blocks.

14. The system as claimed in claim 10, wherein said means for allocating to said user said metadata storage range comprises:
means for identifying said user with a user name;
means for identifying said metadata storage range with a metadata storage range name;
means for specifying a block offset into said logical volume where said metadata storage range begins; and,
means for specifying a block range length of said metadata storage range.

15. The system as claimed in claim 10, wherein said mean for allocating to said user said data storage range comprises:
means for identifying said user with a user name;
means for identifying said data storage range with a data storage range name;
means for specifying a block offset into said logical volume where said data storage range begins; and,
means for specifying a block range length of said data storage range.

16. The system as claimed in claim 10, wherein:
said means for allocating to said user said metadata storage range comprises:
means for identifying said user with a user name;
means for identifying said metadata storage range with a metadata storage range name;
means for specifying a block offset into said logical volume where said metadata storage range begins; and,
means for specifying a block range length of said metadata storage range; and,
said means for allocating to said user said data storage range comprises:
means for identifying said data storage range with a data storage range name;
means for specifying a block offset into said logical volume where said data storage range begins; and,
means for specifying a block range length of said data storage range.

17. The system as claimed in claim 16, further comprising:
means for allocating to said user a range of contiguous blocks within said data storage range for storage of a first file.

18. The system as claimed in claim 17, wherein said means for allocating to said user a range of contiguous blocks within said data storage range for storage of said first file comprises:
means for specifying a name for said first file;
means for specifying said metadata storage name range for said first file;
means for specifying said data storage range name for said first file;
means for specifying an offset into said data storage range for said first file; and,
means for specifying a length for said first file.

19. A computer program product in computer readable storage medium, which comprises:
instructions stored in a computer readable storage medium for determining a range of unallocated contiguous blocks in a file system;
instructions stored in a computer readable storage medium for allocating to a user a metadata storage range of contiguous blocks within said range of unallocated contiguous blocks; and,
instructions stored in a computer readable storage medium for allocating to said user a data storage range of contiguous blocks within said range of unallocated contiguous blocks.

20. The computer program product as claimed in claim 19, further comprising:
instructions stored in a computer readable storage medium for allocating to said user a range of contiguous blocks within said data storage range for storage of a first file.

21. The computer program product as claimed in claim 20, further comprising:
instructions stored in a computer readable storage medium for saving metadata associated with said first file in said metadata storage range allocated to said user; and,
instructions stored in a computer readable storage medium for saving said first file in said range of contiguous blocks allocated for storage of said first file.

22. The computer program product as claimed in claim 21, wherein:
said instructions stored in a computer readable storage medium for allocating to said user said metadata storage range comprises:
instructions stored in a computer readable storage medium for identifying said user with a user name;
instructions stored in a computer readable storage medium for identifying said metadata storage range with a metadata storage range name;
instructions stored in a computer readable storage medium for specifying a block offset into said logical volume where said metadata storage range begins; and,
instructions stored in a computer readable storage medium for specifying a block range length of said metadata storage range; and,
said instructions stored in a computer readable storage medium for allocating to said user said data storage range comprises:
instructions stored in a computer readable storage medium for identifying said data storage range with a data storage range name;
instructions stored in a computer readable storage medium for specifying a block offset into said logical volume where said data storage range begins; and,
instructions stored in a computer readable storage medium for specifying a block range length of said data storage range.

23. The computer program product as claimed in claim 19, further comprising:
instructions stored in a computer readable storage medium for allocating to said user a range of contiguous blocks within said data storage range for storage of a first file.

24. The computer program product as claimed in claim 23, wherein said instructions stored in a computer readable storage medium for allocating to said user a range of contiguous blocks within said data storage range for storage of said first file comprises:
instructions stored in a computer readable storage medium for specifying a name for said first file;
instructions stored in a computer readable storage medium for specifying said metadata storage name range for said first file;
instructions stored in a computer readable storage medium for specifying said data storage range name for said first file;
instructions stored in a computer readable storage medium for specifying an offset into said data storage range for said first file; and,
instructions stored in a computer readable storage medium for specifying a length for said first file.
